(19) United States
(12) Patent Application Publication
(10) Pub. No.: US 2013/0198092 A1
(43) Pub. Date: Aug. 1, 2013

(54) COMPUTER-ASSISTED PATENT APPLICATION PREPARATION

(71) Applicants: Benedict R. Dugan, Seattle, WA (US); Ellen M. Bierman, Bellevue, WA (US)

(72) Inventors: Benedict R. Dugan, Seattle, WA (US); Ellen M. Bierman, Bellevue, WA (US)

(21) Appl. No.: 13/756,311

(22) Filed: Jan. 31, 2013

Related U.S. Application Data
(60) Provisional application No. 61/593,619, filed on Feb. 1, 2012.

(51) Int. Cl. G06Q 50/18; G06Q 99/00

(52) U.S. Cl. CPC G06Q 50/184; G06Q 99/00
USPC 705/310

(57) ABSTRACT

Techniques for computer-assisted patent application preparation are described. Some embodiments provide a Patent Application Preparation System (“PAPS”) that facilitates the automatic generation of patent applications (or portions thereof) based on logical claim definitions. The PAPS may receive one or more claim definitions that each define a single patent claim. From these claim definitions, the PAPS may generate claims, figures, written description corresponding to the figures, summary sections, and the like. When a drafter modifies a claim definition, the application portions may be automatically regenerated, so that any changes (e.g., to claim position or terminology) are reflected in the resulting patent application.

### TECHNICAL FIELD

The present disclosure relates to methods, techniques, and systems for computer-assisted patent application preparation.

### COMPUTER PROGRAM LISTING APPENDIX

Submitted concurrently herewith via the USPTO's electronic filing system, and incorporated herein by reference, is a computer program listing that includes instructions, routines, and/or other contents of a computer program. The computer program listing is for one computer file that represents a claim definition file used to automatically generate portions of the present application according to one embodiment of the invention. The computer program listing includes a file named “patent-prep-1-claims.txt”, created on Jan. 21, 2013, last modified on Jan. 31, 2013, having a file size of 25,685 bytes. The computer program listing includes claim definitions written in one embodiment of a Claim Definition Language, as further described below.

### BRIEF DESCRIPTION OF THE DRAWINGS

FIG. 1 is a block diagram illustrating example data flows according to an example embodiment.

FIG. 2 is an example functional block diagram of an example patent application preparation system according to an example embodiment.

FIGS. 3.1-3.3 are example flow diagrams generated by an example embodiment.

FIGS. 4.1-4.24 are example flow diagrams of automated patent application preparation processes performed by example embodiments.

FIG. 5 is a user interface screen configured to facilitate generation, revisions, and management of claim definitions according to an example embodiment.

FIG. 6 is an example block diagram of an example computing system for implementing a patent application preparation system according to an example embodiment.

### DETAILED DESCRIPTION

Embodiments described herein provide enhanced computer- and network-based methods and systems for computer-assisted patent application preparation. Example embodiments provide a Patent Application Preparation System (“PAPS”). The PAPS may receive logical claim definitions and automatically generate portions of a patent application based thereon, including claims, figures, written description, or the like, as discussed further below.

The preparation of patent applications can be a tedious and error-prone process. For example, when claims are added during the drafting or review process, the numbering of existing patent claims (and their dependencies) may need to be revised, which may be a labor-intensive and error-prone operation. In addition, if preferred terminology changes (e.g., based on inventor feedback or a refined understanding of the prior art), a simple search-and-replace may not be sufficient to correctly modify a given term throughout a patent document or a section thereof. As another example, complying with statutory requirements such as enablement or written description may require the generation of figures (e.g., flow diagrams) that reflect the content of the claims. Such figures may need to be consistent with the claims and/or language used therein, such that changes to the claims may also result in changes to corresponding figures.

Embodiments of the PAPS and the described techniques allow the patent drafter (e.g., patent attorney, patent agent, pro se inventor) to focus on drafting patent claims, which is an area where they can provide considerable value to the patent application process. By expressing patent claims as claim definitions in a well-defined claim definition language, the PAPS can automatically generate numbered patent claims, as well as other portions of an application, such as figures, corresponding written description, summary text, and the like. At the same time, the PAPS frees the patent drafter from many of the time-consuming and/or error-prone aspects of patent application preparation, such as claim numbering, reference numbering, figure generation, and the like.

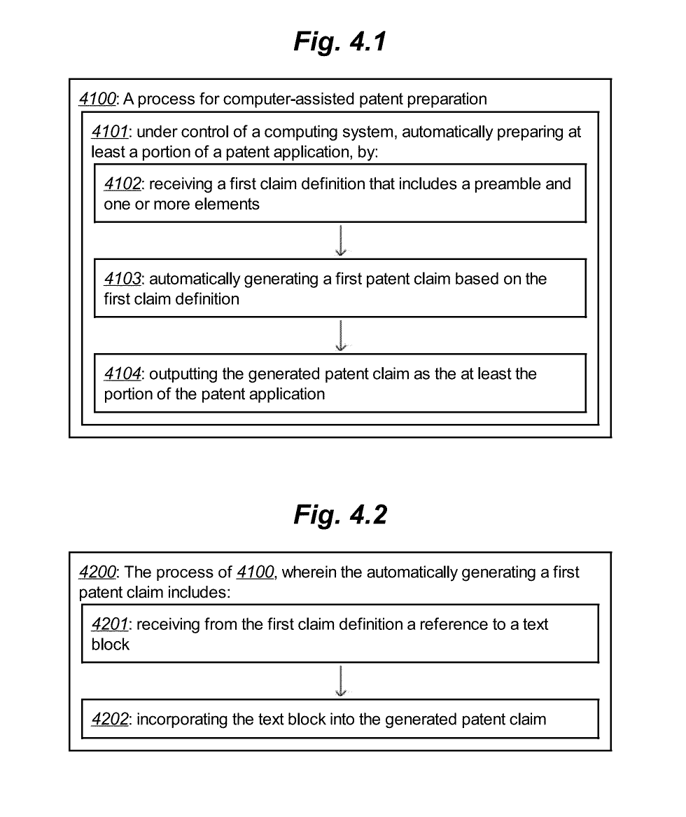

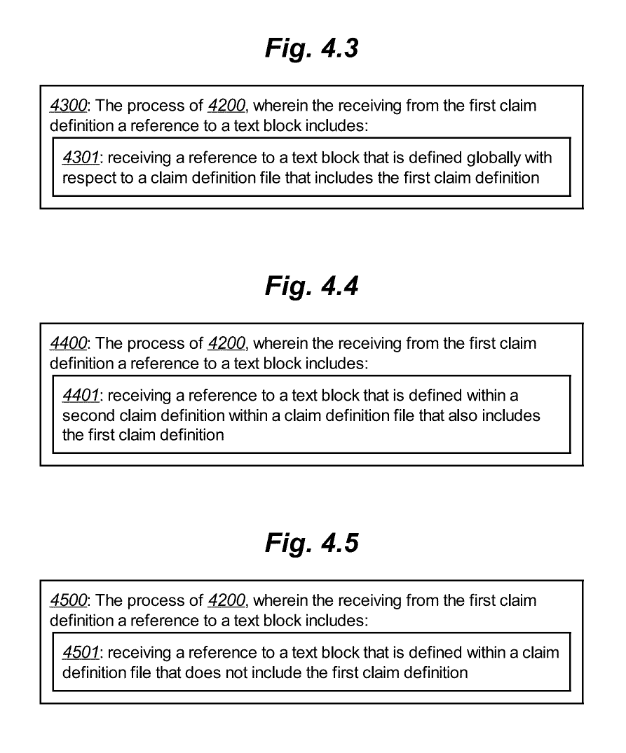

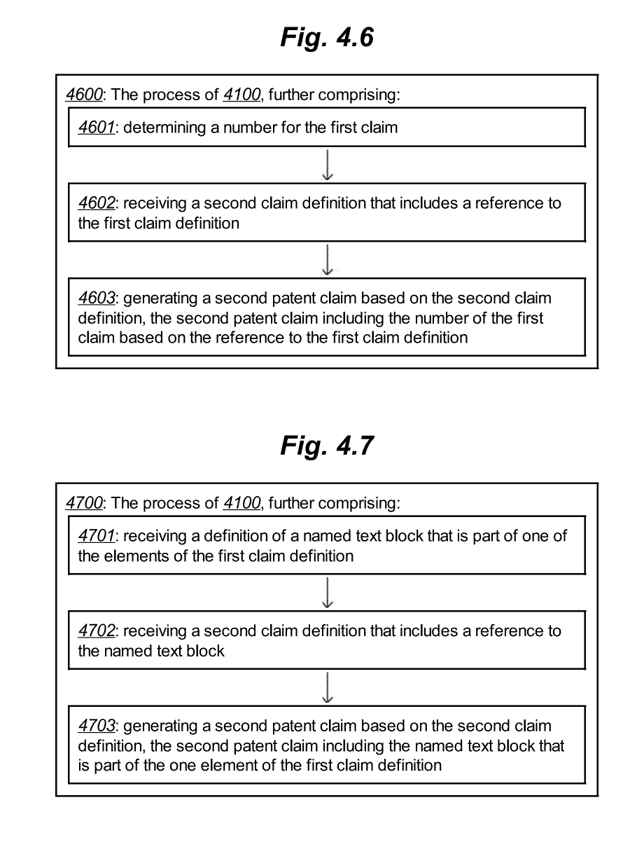

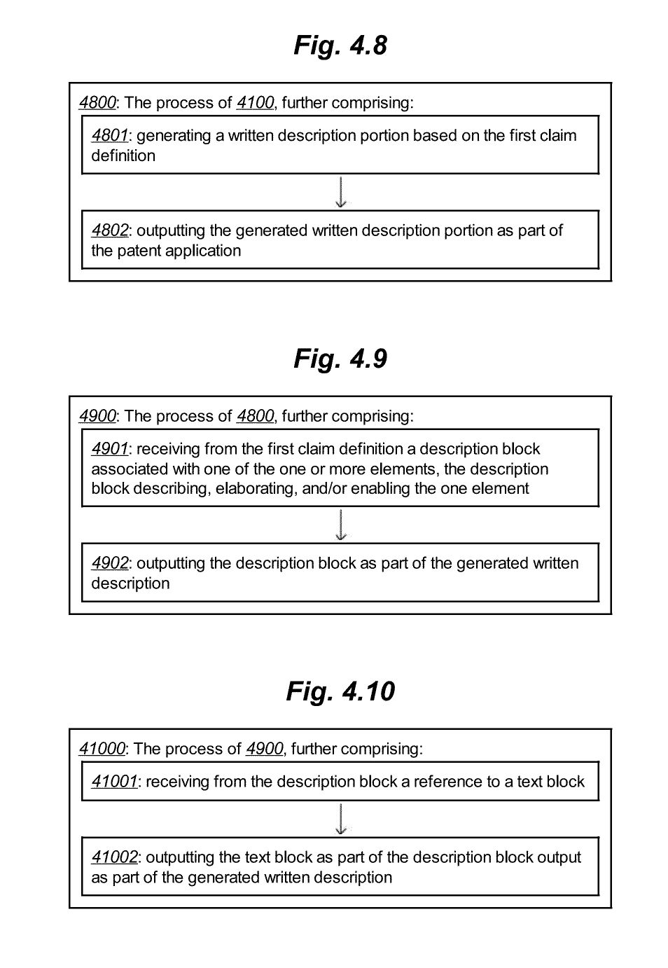

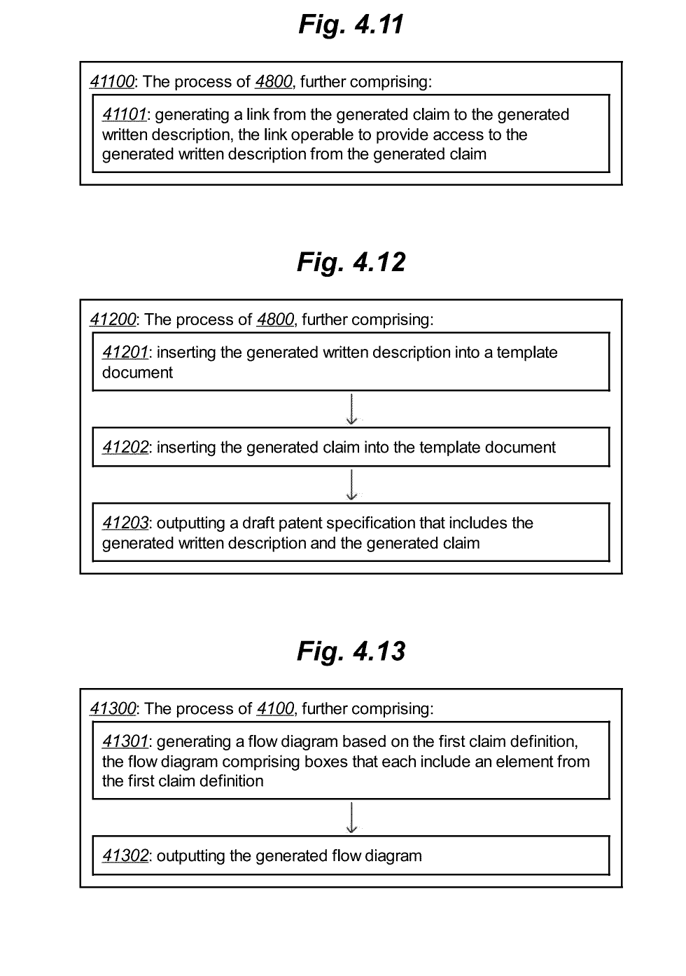

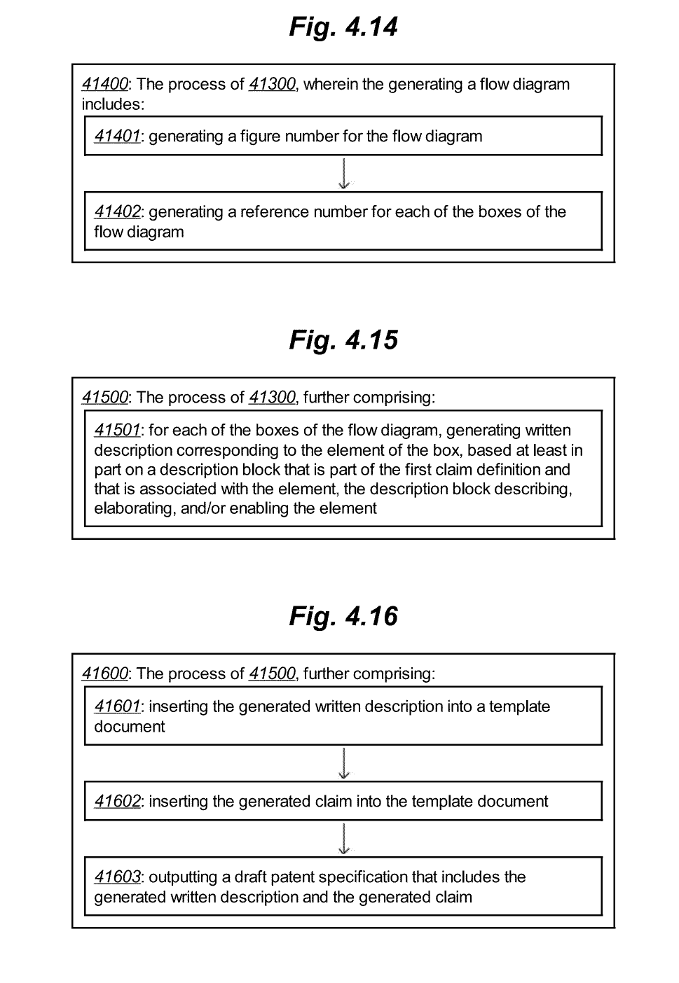

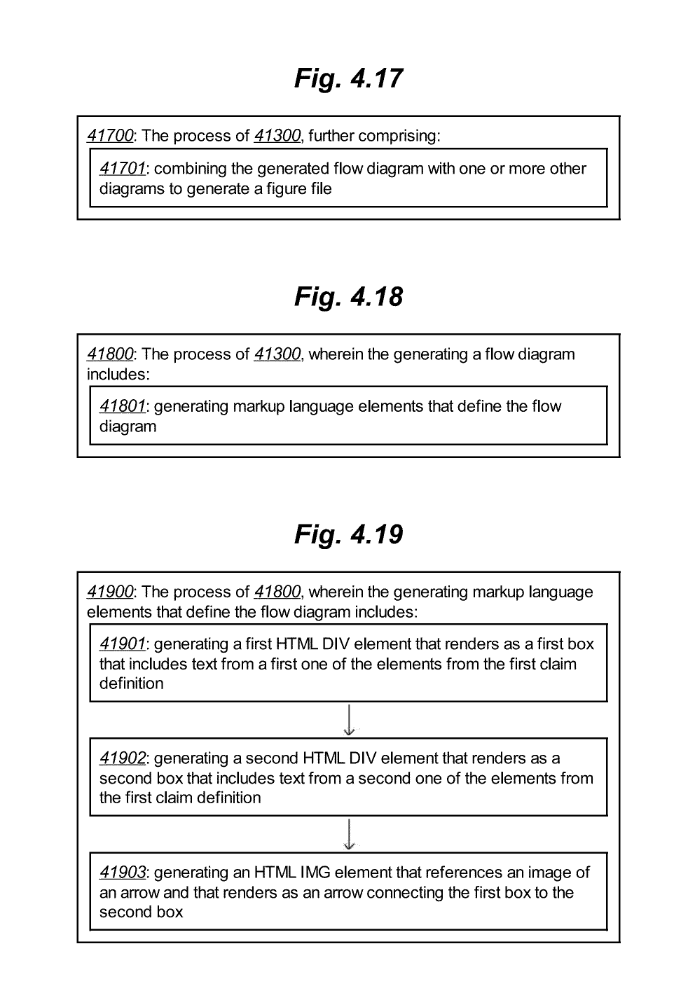

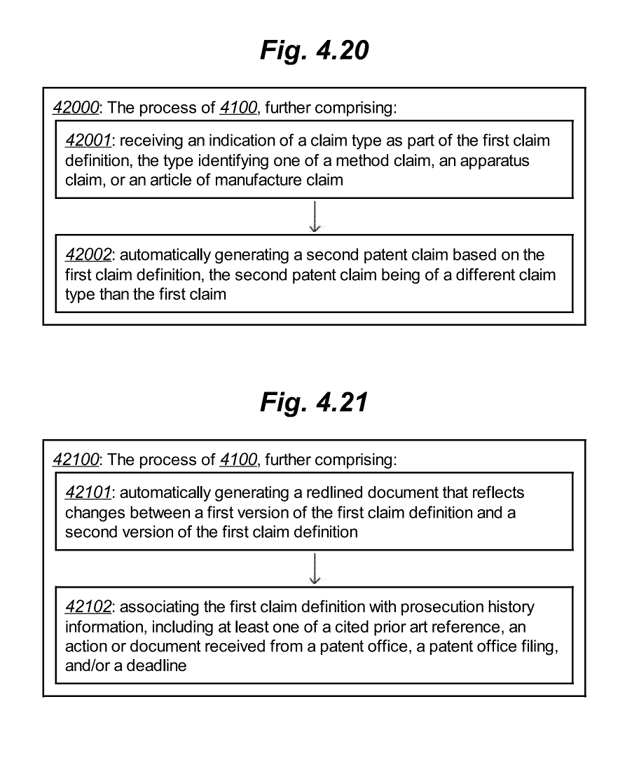

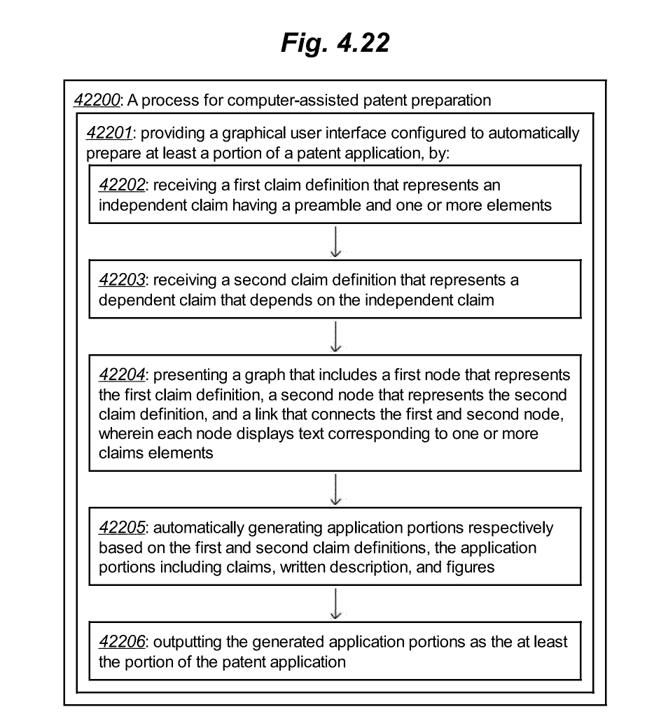

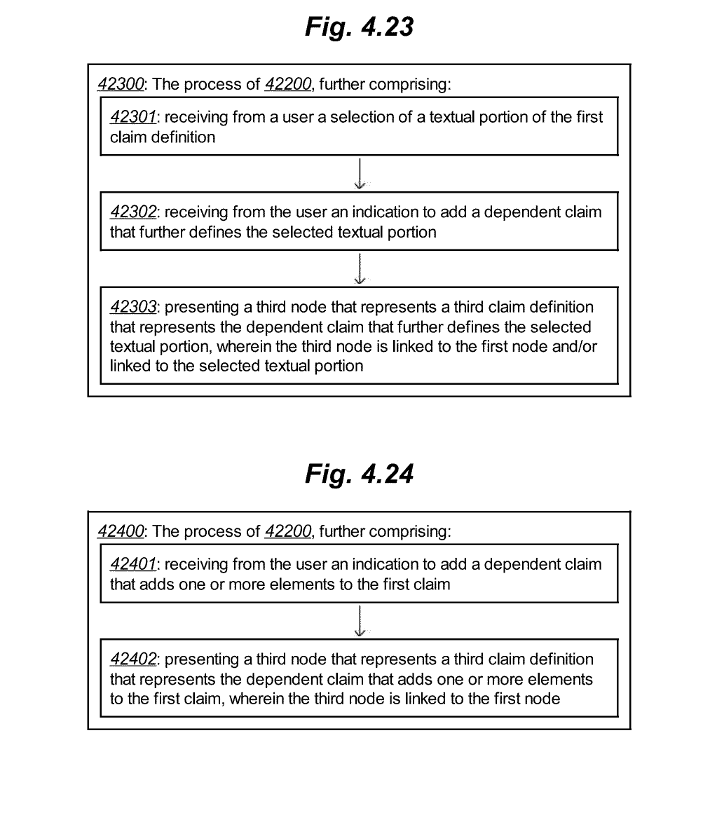

As will be discussed further below, this patent application has itself been prepared using at least some of the described techniques. Thus, this patent application is a product or output of an example embodiment. More particularly, the claims, FIGS. 4.1-4.24, and the written description corresponding to FIGS. 4.1-4.24 have been automatically generated by an example PAPS based on a file that includes multiple logical claim definitions prepared by the drafter. This claims definition file is included herewith as a Computer Program Listing Appendix file named “patent-prep-1-claims.txt.”

### 1. Patent Application Preparation System Overview

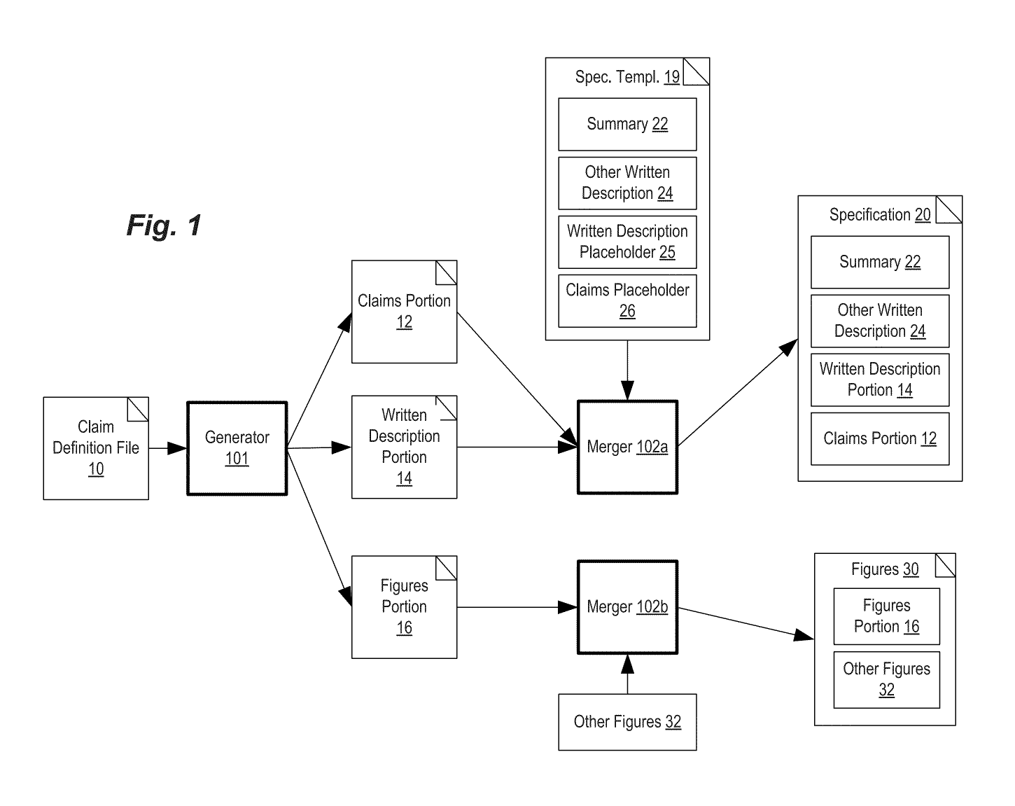

FIG. 1 is a block diagram illustrating example data flows according to an example embodiment. In particular, FIG. 1 illustrates the generation of a patent specification file 20 and figures file 30 based on a claim definition file 10.

The data flows illustrated in FIG. 1 begin with the claim definition file 10. The claim definition file 10 includes one or more claim definitions expressed in a claim definition language. A claim definition language (“CDL”) is a formal syntax for expressions and/or statements (e.g., claim definitions, name-value definitions) along with a corresponding semantics for generating portions of a patent application based on such expressions or statements. A claim definition language may be analogized to a programming language for generating patent applications (or portions thereof).

A. Example Claim Definition Language

The following describes an example claim definition language according to an example embodiment. In other embodiments, a claim definition language may have different syntax (e.g., an XML-based format) and/or semantics.

(i) Defining a Claim

A CDL claim definition file includes one or more claim definitions. Independent claim definitions are introduced with the keyword meth, sys, or crm. The pattern for an independent claim definition is as follows:

```
meth|sys|crm preambleWord+ {
  element1;
  element2;
  . . .
  elementN;
}
```

The following example defines a method claim having three steps:

```
// this is a comment, we are defining a new method claim:
meth for packing a lunch {
  selecting a fruit;
  making a sandwich;
  packing the fruit and the sandwich into a container;
}
```

The generator will consume the above definition and produce a claim that may be rendered as the following text:
1. A method for packing a lunch, comprising:
   selecting a fruit;
   making a sandwich; and
   packing the fruit and the sandwich into a container.

(ii) Naming Claim Aspects

Often it is useful to name claim aspects or portions, so that they can be referenced in other parts of the claim, or in other claims. In general, this is accomplished by using the $name=(word+) pattern. For example:

```
meth for packing a lunch {
  selecting a $f = (fruity treat);
  making a $s = (sandwich);
  packing the $f and the $s into a container;
}
```

The above fragment defines two variables, $f and $s, which can be referenced in other parts of the claim, in other claims, or in other claim definition files. In particular, the reference $f in “packing the $f . . . ” will be replaced, resulting in “packing the fruity treat . . . ” The named text blocks can also be referenced in dependent claims, as below.

(iii) Dependent Claims

Dependent claims may also be defined. To do so, there must exist a named parent claim definition. As when naming claim aspects, claim names begin with a $, like so:

$A=meth for packing a lunch { . . . }.

Given a named parent claim, as above, a dependent claim that depends on the parent claim may be defined by using the dep keyword, like so:

dep $A { . . . }

In addition to a generic syntax for defining the body of a dependent claim, this embodiment of CDL also provides language-level support for three commonly used claim patterns, discussed further below: (1) the fc keyword for “further comprising type” dependents; (2) the wi keyword for “wherein type” dependents; and (3) the wi . . . fc pattern for “wherein/further comprising type” dependents.

An example “further comprising type” (or “FC type” for short) claim definition is as follows:

dep $A fc {
selecting a drink;
}

The generator will consume the above definition (along with the independent claim shown above) and render a claim such as:
2. The method of claim 1, further comprising:
selecting a drink.

To define a meaningful “wherein type” (or “WI type” for short) claim, there should be a named portion of the parent claim that is to be refined, so that that named portion can be referred to in the dependent claim. As shown above, a claim portion can be named using the $ name=( . . . ) pattern, for example:

```
$A = meth for packing a lunch {
  $a = (selecting a fruit);
  making a sandwich;
  packing the fruit and the sandwich into a $con = (container);
}
dep $A wi $a includes {
  picking the fruit from a tree;
}
dep $A wi $con is a lunch box;
```

The above example defines an independent claim having two dependent claims.

The first dependent claim provides an example of what it means to select a fruit. The second dependent claim provides an example of what is meant by a container. The generator will consume the above definitions and render claims such as:
1. A method for packing a lunch, comprising:
   selecting a fruit;
   making a sandwich; and
   packing the fruit and the sandwich into a container.
2. The method of claim 1 wherein the selecting the fruit includes:
   picking the fruit from a tree.
3. The method of claim 1 wherein the container is a lunch box.

In general, this example CDL supports two patterns for wherein type claims, a general form and a short form. The general form is preferred when refining a method step with additional method steps. The short form is preferred when refining a noun or structural element. The pattern for the general form wherein-type claim is:

dep $parentClaimRef wi $elementRef transitionWord+ { element;+ }

The pattern for the short form wherein-type claim is:

dep $parentClaimRef wi $elementRef word+;

The third pattern allows definition of a “wherein/further comprising type” (or “WI/FC type” for short) claim. The syntax for a WI/FC type dependent claim definition is as follows:

dep $parentClaimRef wi $elementRef word+ fc { element;+ }

The WI/FC type syntax supports a common claim pattern in which some structural element (or noun) of the parent claim is refined (with a wherein clause) and then additional elements, such as method steps, are added. Here is an example:

dep $A wi $con is a lunch box fc {
packing the lunch box;
}

In the above example, the “container” is defined to be a “lunch box,” and the step of packing the lunch box is added. The generator would generate a claim like:
4. The method of claim 1, wherein the container is a lunch box, and further comprising:
   packing the lunch box.

(iv) Variable Scope

In this example CDL, each claim defines a scope. CDL supports a system of nested claim scopes. When looking up a reference, the current claim scope is first searched, and if no matching definition is found there, subsequent parent scopes are searched. Thus, reference names can be reused and will shadow their parent definitions. If a name is shadowed, it is reachable by using “dot” notation: $AncestorName.variableName. For example:

```
$A = meth for doing stuff {
  receiving an $a = (item);
  doing something with the $a;
}
dep $A fc {
  selecting some $a = (things);
  transmitting the $a and the $A.a;
}
```

In the dependent claim above, the definition $a=(things) shadows the definition $a=(item) from the parent claim. Thus, in the dependent claim, the reference $a will evaluate to “things” and not “item.” However, one can still access the $a defined in the parent with $A. $a. In the above example, the last step thus evaluates to “transmitting the things and the item.”

(v) Generating Written Description

As discussed in more detail below, the generator may automatically generate figures based on the defined claims, such as by generating flow diagrams from method claims. This example CDL also supports including text after an element that should be included in a written description describing the figure portion (e.g., box) corresponding to the claim element. The pattern for introducing such text is as follows:

meth . . . {
elementWord+ [textWords+];
}

For example:

```
$A = meth for packing a lunch {
  $a = (selecting a fruit)
      [In some embodiments, $a includes picking fruits from
      trees, bushes, or the like. In some embodiments, $a
      may also or instead include purchasing fruit from the
      market.];
  making a sandwich
    [This may include choosing bread and condiments and
    assembling the parts of the sandwich.];
  packing the fruit and the sandwich into a $con = (container)
  [The $con may be a lunchbox or tupperware, or the like.];
}
```

(vi) Global Variables

This example CDL supports global variables. The following example defines two globals, $iso and $fruit for frequently used claim or written description aspects. Note that parentheses are not required when defining a global in this example CDL.

```
$iso = In some embodiments;
$fruit = fruity treat;
$A = meth for packing a lunch {
  $a = (selecting a $fruit)
[$iso, $a includes picking fruits from trees.];
  . . .
}
```

(vii) Automatically Generating Other Claim Types

The claim generator can generate claims in multiple statutory classes, based on a single claim definition. For example, given:

```
meth for packing a lunch {
  selecting a fruit;
  making a sandwich;
  packing the fruit and the sandwich into a container;
}
```

The generator may also generate a computer-readable medium claim and a system claim based on the above definition, resulting in the following three claims:
1. A method for packing a lunch, comprising:
   selecting a fruit;
   making a sandwich; and
   packing the fruit and the sandwich into a container.
2. A non-transitory computer-readable medium having contents that are configured, when executed, to cause a computing system to perform a method for packing a lunch, the method comprising:
   selecting a fruit;
   making a sandwich; and
   packing the fruit and the sandwich into a container.
3. A computing system for packing a lunch, the computing system comprising:
   a processor;
   a memory; and
   a module that is stored in the memory and that is configured, when executed by the processor, to perform a method comprising:
      selecting a fruit;
      making a sandwich; and
      packing the fruit and the sandwich into a container.

(viii) Generating Figures without Corresponding Claims

Sometimes, it is useful to generate a figure for inclusion in the application, where the figure does not have a corresponding claim. For example, the figure may be included to support a future continuation that pursues a related aspect of the invention (e.g., a client component/method of a client-server system).

To generate a figure while suppressing the generation of a claim, use the noclaim keyword preceding the subject claim definition, for example:

```
noclaim
meth for eating a lunch {
  opening a container;
  eating food from the container;
}
```

The above definition will result in the generation of a figure, but no claim. If claim generation is suppressed for a parent claim, then all of its descendent claims will also be suppressed.

(ix) Generating Figures for Specific Claims

In one mode, the generator will automatically generate a figure for each method claim. In another mode, figure generation can be specified on a per-claim basis, using the genfig keyword, for example:

```
genfig
$A = meth for eating a lunch {
  $a = (opening a container);
  eating food from the container;
}
dep $A wi $a includes {
  opening a lunchbox;
}
```

The above definitions will result in the generation of a figure as well as the corresponding claim for claim definition $A, but not for its dependent claim. If figure generation is specified for a child claim, then figure generation for all ancestor claims is implied.

The genfig and noclaim keywords can be combined, for example:

```
genfig noclaim
$A = meth for eating a lunch {
  $a = (opening a container);
  eating food from the container;
}
```

The above definition will result in the generation of a figure but not a corresponding claim for claim definition $A.

Note that the above claim definition language is an example language used by some embodiments. Other embodiments may use claim definition languages that are different in appearance, syntax, and/or semantics. For example, different or additional keywords may be provided. Different claim patterns may be supported. An XML-based (or other style) syntax may be used.

B. Operation of Example Patent Application Preparation System

Returning now to the example of FIG. 1, a generator 101 consumes the claim definition file 10 as input. The generator 101 may include a parser or other module to generate a structure (e.g., a parse tree) based on the claim definition file 10. The generator 101 may then traverse the generated structure and generate, according the semantics of the claim definition language, a claims portion 12, a written description portion 14, and a figures portion 16. In the illustrated embodiment, the generator 101 generates and stores in the claims portion 12 a claim corresponding to each claim defined in the claim definition file 10. The generator 101 also generates and stores in the figures portion 16 a flow diagram figure for each method claim in the claim definition file 10. The generator 101 further generates and stores in the written description portion 14 written description text paragraphs corresponding to each of the generated figures.

Generation of the portions 12, 14, and 16 may also be based on other factors or inputs, such as user preferences, command line flags, templates, or the like. For example, a user may provide a claim template that defines standard claim formatting, default claim preambles, and the like. The generated portions 12, 14, and 16 may be or include data represented as text, HTML, XML, a binary format (e.g., Microsoft Word, Open Office), or the like. The generated portions 12, 14, and 16 may be stored as intermediary files or in other ways, such as data in a pipe, memory buffer, data structure, or the like. In other embodiments, a greater or lesser number or type of portions may be generated. For example, the generator 101 may also generate a summary portion, an abstract portion, or the like.

Next, a merger 102a consumes the claims portion 12 and the written description portion 14 and merges, inserts, combines, or otherwise incorporates them into a specification template 19 to produce a specification 20. The specification template 19 includes other application parts, such as a summary 22 and other written description 24, which may be human generated. The template 19 may also include a written description placeholder 25 and a claims placeholder 26 that identify locations at which the merger 102a is to insert the claims portion 12 and the written description portion 14, respectively. In some embodiments, the specification template is a Microsoft Word or HTML file that includes some human-generated text, along with tags, bookmarks, or other identifiers that can be used by the merger 102a as insertion points for portions 12 and 14 (and possibly others) generated by the generator 101. Upon inserting the portions 12 and 14, the merger 102a produces the specification 20. The specification includes the summary 22 and the other written description 24 (from the template 19), along with the written description portion 14 and the claims portion 12.

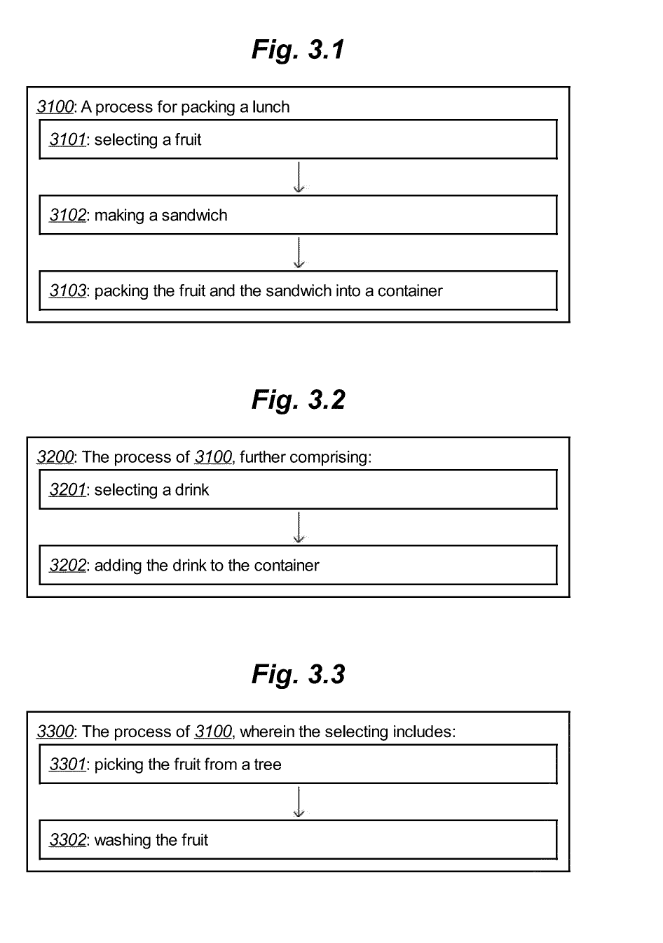

Next, a merger 102b consumes the figures portion 16 and other figures 32 and combines them to produce figures 30. The figures 30 may be a PDF file that includes the figures portion 16 along with the other figures 32. The other figures 32 may be human-generated or obtained from other sources. In the present application, for example, other figures 32 include human-generated FIGS. 1, 2, 5, and 6, while figures portion 16 includes the flow diagrams of FIGS. 4.1-4.24. As discussed below, FIGS. 3.1-3.3 are also automatically generated, based on the claim definitions in Table 1. In some embodiments, the figures portion 16 may be converted prior to incorporation into the Figures 30. For example, if the figures portion 16 is represented as an HTML file, that file may be first rendered into PDF or other format and then merged with the other figures 32 to produce the figures 30.

Note the advantages that are obtained from the described techniques. In particular, the patent drafter focuses his energy on preparing the claim definition file. He may prepare, edit, and/or revise the claim definition file and then request the automatic generation of the specification 20 and figures 30. Changes to the claim definition file, such as modified language, typo fixes, claim revisions, or the like, are automatically propagated throughout the application to all of the relevant locations/portions, such as the claims, figures, and written description.

In other embodiments, other functions may be performed. For example, the generator 101 may be configured to produce additional application portions, such as a summary, abstract, or the like. Other types of figures may be generated. For example, the generator may generate structural diagrams based on apparatus claims.

C. Example Claim Definition File

A claim definition file according to the above claim definition language is used to generate portions of the present patent application. Specifically, the claim definition file provided herewith as a Computer Program Listing Appendix named “patent-prep-1-claims.txt” is used to generate the claims, FIGS. 4.1-4.24, and the written description corresponding to those figures. A similar claim definition file was provided as Appendix B to U.S. Provisional Patent Application No. 61/593,619, filed Feb. 1, 2012, and was used to generate portions of that application.

In interest of brevity and simplicity in illustrating the described techniques, a shorter example claim definition file is provided in Table 1, below.

```
TABLE 1
// Example claims (this is a comment)
// Globals
$iso = In some embodiments;
// Independent claim
genfig
$A = meth for packing a lunch {
  $a = (selecting) a $f = (fruit)
  [$iso, $a includes picking fruit from trees, bushes, or the like.];
  making a $s = (sandwich)
  [This may include choosing bread and condiments and assembling the
  parts to form a sandwich.];
  packing the $f and the $s into a $c = (container)
  [The $c may be lunchbox, paper sack, or the like.];
}
// FC-type dependent claim
genfig
$A1 = dep $A fc {
  selecting a drink
  [Selecting the drink may include selecting a drink from a
  refrigerator.];
  adding the drink to the $c;
}
// WI-type dependent claims
genfig
$A2 = dep $A wi $a includes {
  picking the $f from a tree
  [In other embodiments, the fruit may be harvested from a bush or
    other plant.];
  washing the $f
  [It's always a good idea to wash fruit before eating it.];
}
// Simple WI-type claim
$A3 = dep $A wi $c is a lunch box;
```

As is evident from the above example, a claim definition file may include multiple claim definitions, each of which includes portions such as a claim name, a claim reference, claim type, claim preamble type, claim body (e.g., elements), written description text (e.g., within the [and] characters, sometimes called “description blocks”), and the like. The claim definition file may also name or tag text blocks (e.g., with the $ name=( . . . ) syntax), such that these text blocks can be referenced in claim bodies and other portions of a claim definition. Note that claims that have no dependents need not be named. Thus the claims named $A1, $A2, and $A3 could be represented without such names (as “anonymous” claims). Also, the particular naming scheme is based on user preference. Thus, for example, claim $A could be named $main or otherwise.

Given the example claim definition file provided above in Table 1, the generator 101 will output the following claims portion 12 shown in Table 2, below:

```
TABLE 2
<html><head>
  <title>Generated Claims</title>
  <style>@import url(“resources/style.css”);</style>
</head><body>
<div class=“claim_preamble”>
1. <a href=“#cg_3100”>
A method for packing a lunch</a>, the method comprising:</div>
<div class=“claim_indent_1”>
<a href=“#cg_3101”>selecting a fruit</a>; </div><div
    class=“claim_indent_1”>
<a href=“#cg_3102”>making a sandwich</a>; and</div><div
    class=“claim_indent_1”>
<a href=“#cg_3103”>packing the fruit and the sandwich into a
    container</a>. </div>
<div class=“claim_preamble”>
2. <a href=“#cg_3200”> The method of claim 1</a>, further comprising:
</div>
<div class=“claim_indent_1”>
<a href=“#cg_3201”>selecting a drink</a>; and</div><div
    class=“claim_indent_1”>
<a href=“#cg_3202”>adding the drink to the container</a>. </div>
<div class=“claim_preamble”>
3. <a href=“#cg_3300”>
The method of claim 1</a>, wherein the selecting includes:
</div>
<div class=“claim_indent_1”>
<a href=“#cg_3301”>picking the fruit from a tree</a>; and</div><div
    class=“claim_indent_1”>
<a href=“#cg_3302”>washing the fruit</a>. </div>
<div class=“claim_preamble”>
4. <a href=“#cg_3400”>
The method of claim 1</a>, wherein the container is a lunch box.
</div>
</body></html>
```

The HTML code shown in Table 2 may then be incorporated into a claims section of a patent application specification, as discussed above. Note that various portions of the generated HTML are enclosed in anchor elements (<a href=“ . . . ”> . . . </a>). These HTML anchor elements are rendered as links that facilitate access to other portions of the patent application document, such as the written description. In this manner, a claim and/or its elements may be linked to portions of the written description that describe, enable, or otherwise support that claim (or its elements). Linking claims and written description facilitates efficient review, so that a reviewer who is reading a claim can click on a portion of that claim (e.g., a claim step) and be taken to the paragraph or section of the written description that provides support for that claim portion. In this example, Table 4, below, includes written description portions that include targets for the links defined in the generated claims of Table 2.

In addition, given the example claim definition file provided above, the generator 101 will output the following figures portion 16 shown in Table 3, below:

```
TABLE 3
<html><head>
  <title>Generated Figures</title>
  <style>@import url(“resources/style-figs.css”);</style>
</head><body>
<div class=“hidden”>
<center><h2><em>Fig. 3.1</em></h2></center>
<div>
<u><em>3100</em></u>: A process for packing a lunch
<div><u><em>3101</em></u>: selecting a fruit </div>
<center><img src=“resources/arrow.jpg”></img></center>
<div><u><em>3102</em></u>: making a sandwich </div>
<center><img src=“resources/arrow.jpg”></img></center>
<div><u><em>3103</em></u>: packing the fruit and the sandwich into a
    container </div></div>
</div>
<div class=“hidden”>
<center><h2><em>Fig. 3.2</em></h2></center>
<div><u><em>3200</em></u>:
The process of <u><em>3100</em></u>, further comprising:
<div><u><em>3201</em></u>: selecting a drink </div>
<center><img src=“resources/arrow.jpg”></img></center>
<div><u><em>3202</em></u>: adding the drink to the container </div>
</div>
</div>
<div class=“hidden”>
<center><h2><em>Fig. 3.3</em></h2></center>
<div><u><em>3300</em></u>:
The process of <u><em>3100</em></u>, wherein the selecting includes:
<div><u><em>3301</em></u>: picking the fruit from a tree </div>
<center><img src=“resources/arrow.jpg”></img></center>
<div><u><em>3302</em></u>: washing the fruit </div></div>
</div>
</body></html>
```

FIGS. 3.1-3.3 are example figures generated based on the HTML produced and shown in Table 3. Specifically, when the HTML code shown in Table 3 is rendered by a typical Web client or other HTML processor (e.g., an HTML to PDF converter) the flow diagrams shown in FIGS. 3.1-3.3 result.

In addition, given the example claim definition file provided above, the generator 101 will output the following written description portion 14 shown in Table 4, below:

```
TABLE 4
<html><head>
  <title>Generated Written Description</title>
  <style>@import url(“resources/style.css”);</style>
</head><body>
<!-- ----------------------------------------------------------- -->
<div class=“wd” id=“cg_3100”> <a name=“cg_3100”>
Figure 3.1 is an example flow diagram </a> of example logic for
packing a lunch. More particularly, Figure 3.1 illustrates a process
3100 that includes operations performed by or at the following
block(s).</div>
<div class=“wd” id=“cg_3101”> <a name=“cg_3101”>
At block 3101</a>, the process performs selecting a fruit</a>.
In some embodiments, selecting includes picking fruit from trees,
bushes, or the like.
</div><div class=“wd” id=“cg_3102”> <a name=“cg_3102”>
At block 3102</a>, the process performs making a sandwich</a>.
This may include choosing bread and condiments and assembling the
parts to form a sandwich.
</div><div class=“wd” id=“cg_3103”> <a name=“cg_3103”>
At block 3103</a>, the process performs packing the fruit and the
sandwich into a container</a>. The container may be lunchbox, paper
sack, or the like.
</div>
<!-- ----------------------------------------------------------- -->
<div class=“wd” id=“cg_3200”> <a name=“cg_3200”>
Figure 3.2 is an example flow diagram </a> of example logic
illustrating an example embodiment of process 3100 of Figure 3.1.
More particularly, Figure 3.2 illustrates a process 3200 that
includes the process 3100, and which further includes operations
performed by or at the following block(s).
</div>
<div class=“wd” id=“cg_3201”> <a name=“cg_3201”>
At block 3201</a>, the process performs selecting a drink</a>.
Selecting the drink may include selecting a drink from a refrigerator.
</div><div class=“wd” id=“cg_3202”> <a name=“cg_3202”>
At block 3202</a>, the process performs adding the drink to the
container</a>.
</div>
<!-- ----------------------------------------------------------- -->
<div class=“wd” id=“cg_3300”> <a name=“cg_3300”>
Figure 3.3 is an example flow diagram </a> of example logic
illustrating an example embodiment of process 3100 of Figure 3.1.
More particularly, Figure 3.3 illustrates a process 3300 that includes
the process 3100, wherein the selecting includes operations
performed by or at one or more of the following block(s).
</div>
<div class=“wd” id=“cg_3301”> <a name=“cg_3301”>
At block 3301</a>, the process performs picking the fruit from a
tree</a>. In other embodiments, the fruit may be harvested from a
bush or other plant.
</div><div class=“wd” id=“cg_3302”> <a name=“cg_3302”>
At block 3302</a>, the process performs washing the fruit</a>.
It's always a good idea to wash fruit before eating it.
</div>
</body></html>
```

The HTML code shown in Table 4 may then be incorporated into a written description portion of a patent application specification, as discussed above. Note that HTML anchor tags are used to define names (<a name=“ . . . ”> . . . </a>) that operate as targets for links defined in the generated claims of Table 2, above.

In addition, in the HTML code shown in Tables 2-4, references (e.g., $ name) used in the claim definition file of Table 1 are replaced with corresponding text blocks or claim numbers, such that the output is human-readable and compliant with statutory and regulatory requirements (e.g., for claim numbering).

The extended example above reinforces and illustrates the advantages of the presently described techniques. For example, suppose the drafter wishes to add a new dependent claim to appear as the second claim. To do so, the drafter edits the claim definition file of Table 1 to include the new claim and then initiates regeneration of the claims, figures, and written description. The claims and figures are automatically renumbered. As another example, suppose the drafter decides to use the term “choosing” rather than “selecting,” or “holder” rather than “container.” To effect these changes, the drafter edits the claim definition file to read “$s=(choosing)” or “$c=(holder)” and then regenerates the claims, figures, and written description. As a result, all occurrences are automatically updated to reflect the new language in the claims, figures, and the like. These and other techniques reduce drafting time and errors, possibly resulting in reduced legal fees.

### 2. Functional Diagram of Example Patent Application Preparation System

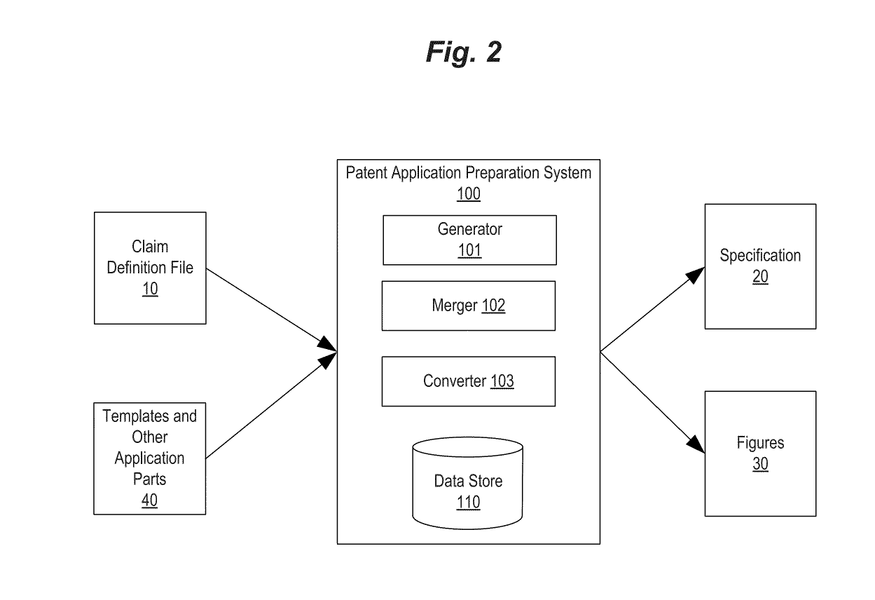

FIG. 2 is an example functional block diagram of an example patent application preparation system according to an example embodiment. In the illustrated embodiment of FIG. 2, the PAPS 100 includes a generator 101, a merger 102, and a converter 103. The PAPS 100 consumes as input a claim definition file 10 and templates and other application parts 40, such as the specification template 19 and other figures 32 described with respect to FIG. 1. The PAPS 100 produces as output the specification 20 and figures 30, as described with respect to FIG. 1.

The generator 101 may include a parser and one or more parse trees (or other structure produced by the parser) traversal modules that are responsible for converting the parse tree into corresponding claims, written description, figures, or the like. In one embodiment, the parser is automatically generated using parser generation techniques, such as LEX and/or YACC.

The merger 102 is responsible for combining or inserting generated portions with or into templates and other application parts 40 in order to form output files such as the specification 20 and/or figures 30.

The converter 103 is responsible for converting or rendering generated portions. For example, a generated portion that is represented in HTML may be rendered by the converter 103 into a PDF file or Microsoft Word file.

One embodiment uses an HTML to PDF converter to convert figures from HTML to PDF. The PDF figures may then be merged with other, possibly manually generated PDF figures to produce a complete figure set. This embodiment also uses Microsoft Word automation libraries to insert claims and written description portions generated in HTML into an application template file represented as a Microsoft Word document.

Other embodiments may include additional modules and/or support other functions. One embodiment may provide a versioning system to track changes to a claim definition file over time. For example, when claims are changed (e.g., due to inventor feedback, during patent prosecution), it is frequently expected that a redline version of the claims will be provided. An example PAPS versioning system can be configured to automatically prepare such a redlined version of the claims based on a first and second version of a claim definition file.

Another embodiment provides support for the patent prosecution process, including the ability to annotate claims with patent prosecution information, including references cited by the examiner, comments or arguments made during the course of patent prosecution, or the like. With such features, the patent prosecutor can efficiently access the history of a particular case, references related to particular claims, and the like.

### 3. Example Processes

FIGS. 4.1-4.24 are example flow diagrams of automated patent application preparation processes performed by example embodiments. The paragraphs below this paragraph, describing FIGS. 4.1-4.24, have been generated and inserted into this document using the techniques described herein. In particular, these paragraphs are generated based on the claim definition file provided herewith as the Computer Program Listing Appendix. In addition, FIGS. 4.1-4.24 and the claims have themselves been generated using the techniques described herein.

FIG. 4.1 is an example flow diagram of example logic for computer-assisted patent preparation. The illustrated logic in this and the following flow diagrams may be performed by, for example, one or more components of the PAPS 100 described with respect to FIG. 2, above. More particularly, FIG. 4.1 illustrates a process 4100 that includes operations performed by or at the following block(s).

At block 4101, the process performs under control of a computing system, automatically preparing at least a portion of a patent application, by: performing operation(s) of block(s) 4102, 4103 and 4104, described below.

At block 4102, the process performs receiving a first claim definition that includes a preamble and one or more elements. Receiving the claim definition may include reading the claim definition from a text file or other source (e.g., network location, graphical user interface interaction with a user). The claim definition may specify various aspects of a claim, including its preamble, type (e.g., method, system, apparatus), dependency (e.g., parent claim), body (e.g., one or more claim elements), and the like. At least some of the information in the claim definition may be symbolically represented. For example, a claim dependency may be indicated by way of an alphanumeric name that references the parent claim. As another example, a claim may reference an element that it further refines by way of an alphanumeric string.

At block 4103, the process performs automatically generating a first patent claim based on the first claim definition. Generating the patent claim may include parsing or otherwise imposing structure (e.g., a parse tree) on the claim definition. Given a parse tree, or similar structure, the process may walk or otherwise traverse the parse tree to generate a textual representation of a patent claim that complies with statutory and regulatory requirements of form. Generating the claim may include resolving references, replacing references with the text blocks they reference, or the like.

At block 4104, the process performs outputting the generated patent claim as the at least the portion of the patent application. The process may write the generated patent claim to a file, transmit the claim over a network, or the like.

FIG. 4.2 is an example flow diagram of example logic illustrating an example embodiment of process 4100 of FIG. 4.1. More particularly, FIG. 4.2 illustrates a process 4200 that includes the process 4100, wherein the automatically generating a first patent claim includes operations performed by or at one or more of the following block(s).

At block 4201, the process performs receiving from the first claim definition a reference to a text block. The first claim definition may reference a text block that is defined globally within a file or within the scope of the first claim definition or some other claim definition. The reference may be a name (e.g., a variable name) that is identified in some manner, such as with a leading dollar sign or other symbol.

At block 4202, the process performs incorporating the text block into the generated patent claim. The process looks up the reference to determine its value (the text block), and then replaces the use of the reference with the referenced text block.

FIG. 4.3 is an example flow diagram of example logic illustrating an example embodiment of process 4200 of FIG. 4.2. More particularly, FIG. 4.3 illustrates a process 4300 that includes the process 4200, wherein the receiving from the first claim definition a reference to a text block includes operations performed by or at one or more of the following block(s).

At block 4301, the process performs receiving a reference to a text block that is defined globally with respect to a claim definition file that includes the first claim definition. As noted, global variables may be supported in some embodiments. For example, a claim file may include bindings of names to commonly used terms or phrases. These names can then be used as references within claim definitions, such that changes to such terms and phrases will be consistently applied throughout a claim set.

FIG. 4.4 is an example flow diagram of example logic illustrating an example embodiment of process 4200 of FIG. 4.2. More particularly, FIG. 4.4 illustrates a process 4400 that includes the process 4200, wherein the receiving from the first claim definition a reference to a text block includes operations performed by or at one or more of the following block(s).

At block 4401, the process performs receiving a reference to a text block that is defined within a second claim definition within a claim definition file that also includes the first claim definition. In some embodiments, each claim definition defines its own scope. These scopes may be nested or linked. For example, a child claim may refer to text blocks that are named in parent claims.

FIG. 4.5 is an example flow diagram of example logic illustrating an example embodiment of process 4200 of FIG. 4.2. More particularly, FIG. 4.5 illustrates a process 4500 that includes the process 4200, wherein the receiving from the first claim definition a reference to a text block includes operations performed by or at one or more of the following block(s).

At block 4501, the process performs receiving a reference to a text block that is defined within a claim definition file that does not include the first claim definition. In some embodiments, the reference may be to a text block located in a claim definition that is different than the claim definition file that includes the first claim definition.

FIG. 4.6 is an example flow diagram of example logic illustrating an example embodiment of process 4100 of FIG. 4.1. More particularly, FIG. 4.6 illustrates a process 4600 that includes the process 4100, and which further includes operations performed by or at the following block(s).

At block 4601, the process performs determining a number for the first claim. The process may perform automatic numbering, which may include automatically assigning numbers to each claim in a claim set.

At block 4602, the process performs receiving a second claim definition that includes a reference to the first claim definition. As noted, dependent claims may refer to their parents by symbolic names (rather than numbers).

At block 4603, the process performs generating a second patent claim based on the second claim definition, the second patent claim including the number of the first claim based on the reference to the first claim definition. The process converts these symbolic references to parent claims into claim numbers during claim generation. This allows the claim developer to focus on more important matters than managing claim and dependency numbers in the face of an evolving claim set.

FIG. 4.7 is an example flow diagram of example logic illustrating an example embodiment of process 4100 of FIG. 4.1. More particularly, FIG. 4.7 illustrates a process 4700 that includes the process 4100, and which further includes operations performed by or at the following block(s).

At block 4701, the process performs receiving a definition of a named text block that is part of one of the elements of the first claim definition. The claim definition may exploit particular syntax to define and name a block of text (e.g., one or more words). By doing this, the claim developer can later refer to a block of text and also be assured that changes to the block of text will be consistently applied when claims are re-generated after changes.

At block 4702, the process performs receiving a second claim definition that includes a reference to the named text block. The second claim definition may refer to the text block for various reasons. In some cases, the second claim definition is a dependent claim that includes a wherein clause that refines the meaning of the text block.

At block 4703, the process performs generating a second patent claim based on the second claim definition, the second patent claim including the named text block that is part of the one element of the first claim definition. The process looks up the referenced text block and incorporates it into the generated patent claim. In this manner, changes to the text block will be reflected consistently throughout the generated claim set.

FIG. 4.8 is an example flow diagram of example logic illustrating an example embodiment of process 4100 of FIG. 4.1. More particularly, FIG. 4.8 illustrates a process 4800 that includes the process 4100, and which further includes operations performed by or at the following block(s).

At block 4801, the process performs generating a written description portion based on the first claim definition. In some embodiments, the process generates written description text, such as a summary, a description of the claim, a description of a corresponding figure, or the like.

At block 4802, the process performs outputting the generated written description portion as part of the patent application. The process may write the generated written description to a file, transmit the claim over a network, or the like.

FIG. 4.9 is an example flow diagram of example logic illustrating an example embodiment of process 4800 of FIG. 4.8. More particularly, FIG. 4.9 illustrates a process 4900 that includes the process 4800, and which further includes operations performed by or at the following block(s).

At block 4901, the process performs receiving from the first claim definition a description block associated with one of the one or more elements, the description block describing, elaborating, and/or enabling the one element. The claim definition may include a description block, which may include text that describes a claim element (or the claim generally).

At block 4902, the process performs outputting the description block as part of the generated written description.

FIG. 4.10 is an example flow diagram of example logic illustrating an example embodiment of process 4900 of FIG. 4.9. More particularly, FIG. 4.10 illustrates a process 41000 that includes the process 4900, and which further includes operations performed by or at the following block(s).

At block 41001, the process performs receiving from the description block a reference to a text block. As discussed with respect to the generation of claim, text blocks may be referenced and incorporated into generated output of the process.

At block 41002, the process performs outputting the text block as part of the description block output as part of the generated written description.

FIG. 4.11 is an example flow diagram of example logic illustrating an example embodiment of process 4800 of FIG. 4.8. More particularly, FIG. 4.11 illustrates a process 41100 that includes the process 4800, and which further includes operations performed by or at the following block(s).

At block 41101, the process performs generating a link from the generated claim to the generated written description, the link operable to provide access to the generated written description from the generated claim. In some embodiments, a link (e.g., an HTML hyperlink) is generated that associates a generated claim (or portion thereof) with corresponding written description. A patent reviewer can activate this link when reading the generated claim in order to be “transported” to the location in the patent application that describes the generated claim (or a figure corresponding thereto).

FIG. 4.12 is an example flow diagram of example logic illustrating an example embodiment of process 4800 of FIG. 4.8. More particularly, FIG. 4.12 illustrates a process 41200 that includes the process 4800, and which further includes operations performed by or at the following block(s).

At block 41201, the process performs inserting the generated written description into a template document. In some embodiments, the generated written description text may be inserted, merged, or incorporated into a template document that includes placeholders, tags, bookmarks, or other identifiers that indicate where the generated written description is to be incorporated.

At block 41202, the process performs inserting the generated claim into the template document. Similarly, the generated claim text may be inserted into the template document. The template document may include portions that are drafted by a human (e.g., such as an overview of the invention or an example of operation) as well as placeholders for the insertion of text generated by the process (e.g., claims, written description, summary).

At block 41203, the process performs outputting a draft patent specification that includes the generated written description and the generated claim.

FIG. 4.13 is an example flow diagram of example logic illustrating an example embodiment of process 4100 of FIG. 4.1. More particularly, FIG. 4.13 illustrates a process 41300 that includes the process 4100, and which further includes operations performed by or at the following block(s).

At block 41301, the process performs generating a flow diagram based on the first claim definition, the flow diagram comprising boxes that each include an element from the first claim definition. In some embodiments, the process may generate flow diagrams based on claim definitions. For example, method claims may naturally be represented as flow diagrams. As another example, structural claims (e.g., to apparatus) may be represented as apparatus diagrams.

At block 41302, the process performs outputting the generated flow diagram. The generated flow diagram may be represented in a markup language (e.g., HTML, VML), in a special purpose diagramming format (e.g., Visio), or the like.

FIG. 4.14 is an example flow diagram of example logic illustrating an example embodiment of process 41300 of FIG. 4.13. More particularly, FIG. 4.14 illustrates a process 41400 that includes the process 41300, wherein the generating a flow diagram includes operations performed by or at one or more of the following block(s).

At block 41401, the process performs generating a figure number for the flow diagram. The process may automatically generate figure numbers.

At block 41402, the process performs generating a reference number for each of the boxes of the flow diagram. In addition, each of the boxes may be assigned a reference number. These reference numbers may then be used when generating written description to correspond to the flow diagram.

FIG. 4.15 is an example flow diagram of example logic illustrating an example embodiment of process 41300 of FIG. 4.13. More particularly, FIG. 4.15 illustrates a process 41500 that includes the process 41300, and which further includes operations performed by or at the following block(s).

At block 41501, the process performs for each of the boxes of the flow diagram, generating written description corresponding to the element of the box, based at least in part on a description block that is part of the first claim definition and that is associated with the element, the description block describing, elaborating, and/or enabling the element. As discussed above, the claim definition may include description blocks that may be used by the process to illuminate the claim or in this case, a corresponding figure.

FIG. 4.16 is an example flow diagram of example logic illustrating an example embodiment of process 41500 of FIG. 4.15. More particularly, FIG. 4.16 illustrates a process 41600 that includes the process 41500, and which further includes operations performed by or at the following block(s).

At block 41601, the process performs inserting the generated written description into a template document. As noted, generated written description text may be inserted, merged, or incorporated into a template document that includes placeholders, tags, bookmarks, or other identifiers that indicate where the generated written description is to be incorporated.

At block 41602, the process performs inserting the generated claim into the template document. Similarly, the generated claim text may be inserted into the template document, as discussed above.

At block 41603, the process performs outputting a draft patent specification that includes the generated written description and the generated claim.

FIG. 4.17 is an example flow diagram of example logic illustrating an example embodiment of process 41300 of FIG. 4.13. More particularly, FIG. 4.17 illustrates a process 41700 that includes the process 41300, and which further includes operations performed by or at the following block(s).

At block 41701, the process performs combining the generated flow diagram with one or more other diagrams to generate a figure file. Because some figures may still be best diagrammed by humans, the process may combine, insert, or merge the generated figures with other diagrams, such as by merging two HTML files, two PDF files, or the like.

FIG. 4.18 is an example flow diagram of example logic illustrating an example embodiment of process 41300 of FIG. 4.13. More particularly, FIG. 4.18 illustrates a process 41800 that includes the process 41300, wherein the generating a flow diagram includes operations performed by or at one or more of the following block(s).

At block 41801, the process performs generating markup language elements that define the flow diagram. Markup languages, such as HTML or Vector Markup Language (“VML”) may be use to represent the flow diagram.

FIG. 4.19 is an example flow diagram of example logic illustrating an example embodiment of process 41800 of FIG. 4.18. More particularly, FIG. 4.19 illustrates a process 41900 that includes the process 41800, wherein the generating markup language elements that define the flow diagram includes operations performed by or at one or more of the following block(s).

At block 41901, the process performs generating a first HTML DIV element that renders as a first box that includes text from a first one of the elements from the first claim definition. In some embodiments, each box is represented as a DIV element with corresponding CSS or other style information that causes a frame or box to be rendered around the DIV.

At block 41902, the process performs generating a second HTML DIV element that renders as a second box that includes text from a second one of the elements from the first claim definition.

At block 41903, the process performs generating an HTML IMG element that references an image of an arrow and that renders as an arrow connecting the first box to the second box. In some embodiments, DIVs may be connected via arrows that are represented as images (e.g., JPG, GIF, PNG files). In a vector-based approach, the arrow may instead be represented as a collection of lines.

FIG. 4.20 is an example flow diagram of example logic illustrating an example embodiment of process 4100 of FIG. 4.1. More particularly, FIG. 4.20 illustrates a process 42000 that includes the process 4100, and which further includes operations performed by or at the following block(s).

At block 42001, the process performs receiving an indication of a claim type as part of the first claim definition, the type identifying one of a method claim, an apparatus claim, or an article of manufacture claim. In some embodiments, the process may automatically generate companion sets of claims that are of different claim types. For example, if the first claim definition is to a method claim, the process may automatically also generate a corresponding system claim and computer-readable medium (e.g, Beauregard-style) claim. Thus the drafter is freed of the burden of error-prone tasks such as having to manage (e.g., number and renumber) such companion claim sets separately, to propagate changes throughout multiple sets, or the like.

At block 42002, the process performs automatically generating a second patent claim based on the first claim definition, the second patent claim being of a different claim type than the first claim.

FIG. 4.21 is an example flow diagram of example logic illustrating an example embodiment of process 4100 of FIG. 4.1. More particularly, FIG. 4.21 illustrates a process 42100 that includes the process 4100, and which further includes operations performed by or at the following block(s).

At block 42101, the process performs automatically generating a redlined document that reflects changes between a first version of the first claim definition and a second version of the first claim definition. In some embodiments, the process is configured to automatically prepare redlined claims to illustrate changes to claims during development or prosecution.

At block 42102, the process performs associating the first claim definition with prosecution history information, including at least one of a cited prior art reference, an action or document received from a patent office, a patent office filing, and/or a deadline. In some embodiments, the process provides prosecution support, by linking prosecution file history information with claim definitions, so that a prosecutor or other person can conveniently and efficiently access such information.

FIG. 4.22 is an example flow diagram of example logic for computer-assisted patent preparation. More particularly, FIG. 4.22 illustrates a process 42200 that includes operations performed by or at the following block(s).

At block 42201, the process performs providing a graphical user interface configured to automatically prepare at least a portion of a patent application, by: performing operation(s) of block(s) 42202, 42203, 42204, 42205 and 42206, described below.

At block 42202, the process performs receiving a first claim definition that represents an independent claim having a preamble and one or more elements. Receiving the claim definition may include reading the claim definition from a text file, user interaction with the provided graphical user interface, or the like.

At block 42203, the process performs receiving a second claim definition that represents a dependent claim that depends on the independent claim. The second claim definition may be received in a similar manner to the first.

At block 42204, the process performs presenting a graph that includes a first node that represents the first claim definition, a second node that represents the second claim definition, and a link that connects the first and second node, wherein each node displays text corresponding to one or more claims elements. The received claim definitions may be presented as a directed or undirected graph comprising nodes that stand for claim definitions. The nodes are linked to represent connections or dependencies between claims.

At block 42205, the process performs automatically generating application portions respectively based on the first and second claim definitions, the application portions including claims, written description, and figures. Generating the patent claim may include traversing the graph or some underlying representation (e.g., a claim definition file that represents the graph) or data structure to generate textual representations of the claims, to generate figures based on the claims, to generate written description (e.g., to describe the figures, summary text), or the like.

At block 42206, the process performs outputting the generated application portions as the at least the portion of the patent application. The process may write the generated portions to a file, transmit the claim over a network, or the like.

FIG. 4.23 is an example flow diagram of example logic illustrating an example embodiment of process 42200 of FIG. 4.22. More particularly, FIG. 4.23 illustrates a process 42300 that includes the process 42200, and which further includes operations performed by or at the following block(s).

At block 42301, the process performs receiving from a user a selection of a textual portion of the first claim definition. This process supports defining a “wherein type” dependent claim. To do so, the user may click on or otherwise select a word or phrase in one of the claim definitions by interacting with the node that displays that claim definition.

At block 42302, the process performs receiving from the user an indication to add a dependent claim that further defines the selected textual portion. The user may click a button or select a menu item to indicate that he wishes to create a dependent claim that refines, defines, or provides an example of what is meant by the selected word or phrase.

At block 42303, the process performs presenting a third node that represents a third claim definition that represents the dependent claim that further defines the selected textual portion, wherein the third node is linked to the first node and/or linked to the selected textual portion. The graphical user interface is updated to display the third node with a link between the third node and the first node or the selected word or phrase displayed by the first node.

FIG. 4.24 is an example flow diagram of example logic illustrating an example embodiment of process 42200 of FIG. 4.22. More particularly, FIG. 4.24 illustrates a process 42400 that includes the process 42200, and which further includes operations performed by or at the following block(s).

At block 42401, the process performs receiving from the user an indication to add a dependent claim that adds one or more elements to the first claim. This process supports defining a “further comprising type” dependent claim. To do so, the user may click a button or select a menu item to indicate this fact.

At block 42402, the process performs presenting a third node that represents a third claim definition that represents the dependent claim that adds one or more elements to the first claim, wherein the third node is linked to the first node. The graphical user interface is updated to display the third node with a link between the third node and the first node.

### 4. Example User Interface

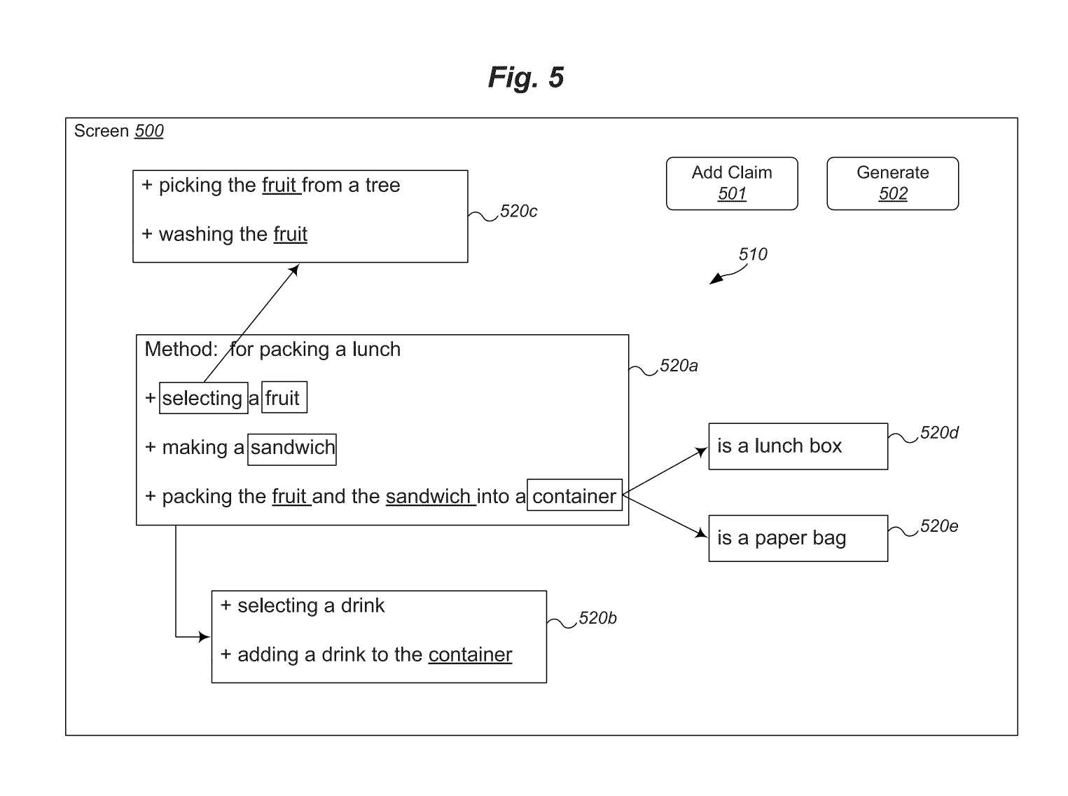

FIG. 5 is a user interface screen configured to facilitate generation, revisions, and management of claim definitions according to an example embodiment. In some embodiments, a user operates a text editor to prepare and revise a claim definition file. After editing, the user then generates patent application portions using a command-line program that implements the techniques described herein. Other embodiments, as illustrated in FIG. 5, provide a customized graphical user interface for preparing claim definitions, visualizing relationships between claims, and generating patent application parts therefrom.

FIG. 5 depicts a user interface screen 500 that displays a claim definition graph 510 and controls 501 and 502 for respectively adding new claims and generating patent application portions. Other controls may be provided.

The graph 510 represents a revised version of the claim definition file of Table 1 above. The graph 510 includes nodes 520a-520e. Nodes 520a-520d respectively represent the claims named $A (the independent claim), $A1, $A2, and $A3 in Table 1.

Within a node, a boxed portion or phrase represents a portion of the claim that has been selected by a user as a target for a reference or for further refinement. For example, within node 520a, boxes are drawn around the terms “selecting,” “fruit,” “sandwich,” and “container” to indicate that these claim terms are reference targets or the subject of further refinement via other claims. When a claim portion is referred to in other parts of the claim or other claims, it is shown in underlining to indicate that a reference is being used. For example, the terms “fruit” and “sandwich” are underlined in node 520a. If the user selects and edits the contents of the box around “fruit,” all references thereto will be automatically updated.

Node 520e represents a claim that has been added by a user, such as by clicking or otherwise selecting the add claim control 501. When the user selects control 501, a new editable node appears. The user then edits text within the node, and links the node to some portion of another claim (e.g., the term “container”).

When the user has edited the graph 510 to his satisfaction, he may select the generate control 502 to cause patent application portions to be automatically generated. Other controls may be provided, including controls to configure the system (e.g., to set up or identify template applications); to save the current graph 510 (e.g., as a claim definition file such as is shown in Table 1); to expand, collapse, or delete nodes, and the like.

### 5. Example Computing System Implementation

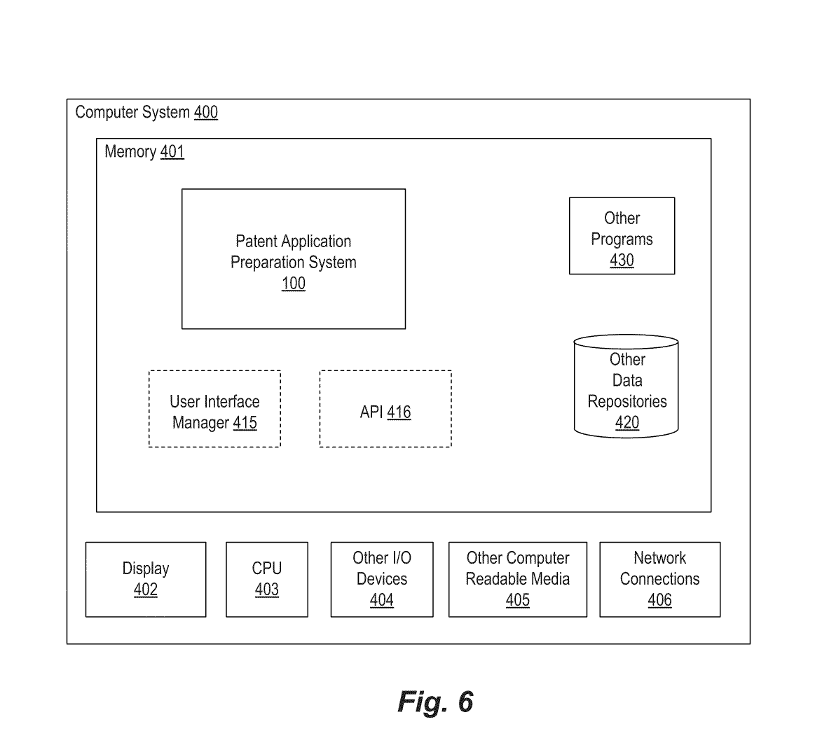

FIG. 6 is an example block diagram of an example computing system for implementing a patent application preparation system according to an example embodiment. In particular, FIG. 6 shows a computing system 400 that may be utilized to implement a PAPS 100.

Note that one or more general purpose or special purpose computing systems/devices may be used to implement the PAPS 100. In addition, the computing system 400 may comprise one or more distinct computing systems/devices and may span distributed locations. Furthermore, each block shown may represent one or more such blocks as appropriate to a specific embodiment or may be combined with other blocks. Also, the PAPS 100 may be implemented in software, hardware, firmware, or in some combination to achieve the capabilities described herein.

In the embodiment shown, computing system 400 comprises a computer memory (“memory”) 401, a display 402, one or more Central Processing Units (“CPU”) 403, Input/Output devices 404 (e.g., keyboard, mouse, CRT or LCD display, and the like), other computer-readable media 405, and network connections 406. The PAPS 100 is shown residing in memory 401. In other embodiments, some portion of the contents, some or all of the components of the PAPS 100 may be stored on and/or transmitted over the other computer-readable media 405. The components of the PAPS 100 preferably execute on one or more CPUs 403 and implement the described techniques. Other code or programs 430 (e.g., an administrative interface, a Web server, and the like) and potentially other data repositories, such as data repository 420, also reside in the memory 401, and preferably execute on one or more CPUs 403. Of note, one or more of the components in FIG. 6 may not be present in any specific implementation. For example, some embodiments may not provide other computer readable media 405 or a display 402.

The PAPS 100 is shown executing in the memory 401 of the computing system 400.

Also included in the memory are a user interface manager 415 and an application program interface (“API”) 416. The user interface manager 415 and the API 416 are drawn in dashed lines to indicate that in other embodiments, functions performed by one or more of these components may be performed externally to the PAPS 100.

The UI manager 415 provides a view and a controller that facilitate user interaction with the PAPS 100 and its various components. For example, the UI manager 415 may provide interactive access to the PAPS 100, such that users can configure the operation of the PAPS 100, such as by editing claim definition files, initiating the generation of patent applications, and the like. In some embodiments, access to the functionality of the UI manager 415 may be provided via a Web server, possibly executing as one of the other programs 430. In such embodiments, a user operating a Web browser executing on one of the third-party systems 455 can interact with the PAPS 100 via the UI manager 415.

The API 416 provides programmatic access to one or more functions of the PAPS 100. For example, the API 416 may provide a programmatic interface to one or more functions of the PAPS 100 that may be invoked by one of the other programs 430 or some other module. In this manner, the API 416 facilitates the development of third-party software, such as user interfaces, plug-ins, adapters (e.g., for integrating functions of the PAPS 100 into Web applications), and the like.

In addition, the API 416 may be in at least some embodiments invoked or otherwise accessed via remote entities, such as code executing on a network-accessible device or system (not shown). For example, a remote system may push claim definitions to the PAPS 100 via the API 416. As another example, a remote system may push prosecution information (e.g., references, office actions) into the PAPS 100 via the API 416. The API 416 may also be configured to provide management or user interface widgets (e.g., code modules) that can be integrated into the third-party applications 455 and that are configured to interact with the PAPS 100 to make at least some of the described functionality available within the context of other applications (e.g., mobile apps).

In an example embodiment, components/modules of the PAPS 100 are implemented using standard programming techniques. For example, the PAPS 100 may be implemented as a “native” executable running on the CPU 403, along with one or more static or dynamic libraries. In other embodiments, the PAPS 100 may be implemented as instructions processed by a virtual machine that executes as one of the other programs 430. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the PAPS 100, such as in the data store 420 (or 110), can be available by standard mechanisms such as through C, C++, C#, and Java APIs; libraries for accessing files, databases, or other data repositories; through scripting languages such as XML; or through Web servers, FTP servers, or other types of servers providing access to stored data. The data store 420 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the PAPS 100 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

All of the above U.S. patents, U.S. patent application publications, U.S. patent applications, foreign patents, foreign patent applications and non-patent publications referred to in this specification and/or listed in the Application Data Sheet, including but not limited to US. Provisional Patent Application No. 61/593,619 filed on Feb. 1, 2012 and entitled “COMPUTER-ASSISTED PATENT APPLICATION PREPARATION,” are incorporated herein by reference, in their entireties.

From the foregoing it will be appreciated that, although specific embodiments have been described herein for purposes of illustration, various modifications may be made without deviating from the spirit and scope of this disclosure. For example, the methods, techniques, and systems patent application preparation are applicable to other architectures or in other settings. For example, instead of preparing patent application documents, at least some of the techniques may be employed to prepare other legal documents, such as agreements, opinions, complaints, answers, counterclaims, patent rule contentions, and the like. Also, the methods, techniques, and systems discussed herein are applicable to differing protocols, communication media (optical, wireless, cable, etc.) and devices (e.g., desktop computers, wireless handsets, electronic organizers, personal digital assistants, tablet computers, portable email machines, game machines, pagers, navigation devices, etc.).

1. A method for computer-assisted patent preparation, the method comprising:
under control of a computing system, automatically preparing at least a portion of a patent application, by:
receiving a first claim definition that includes a preamble and one or more elements;
automatically generating a first patent claim based on the first claim definition; and
outputting the generated patent claim as the at least the portion of the patent application.

2. The method of claim 1, wherein the automatically generating a first patent claim includes:
receiving from the first claim definition a reference to a text block; and
incorporating the text block into the generated patent claim.

3. The method of claim 2, wherein the receiving from the first claim definition a reference to a text block includes: receiving a reference to a text block that is defined globally with respect to a claim definition file that includes the first claim definition.

4. The method of claim 2, wherein the receiving from the first claim definition a reference to a text block includes: receiving a reference to a text block that is defined within a second claim definition within a claim definition file that also includes the first claim definition.

5. The method of claim 1, further comprising:
determining a number for the first claim;
receiving a second claim definition that includes a reference to the first claim definition; and
generating a second patent claim based on the second claim definition, the second patent claim including the number of the first claim based on the reference to the first claim definition.

6. The method of claim 1, further comprising:
receiving a definition of a named text block that is part of one of the elements of the first claim definition;
receiving a second claim definition that includes a reference to the named text block; and
generating a second patent claim based on the second claim definition, the second patent claim including the named text block that is part of the one element of the first claim definition.

7. The method of claim 1, further comprising:
generating a written description portion based on the first claim definition; and
outputting the generated written description portion as part of the patent application.

8. The method of claim 7, further comprising:
receiving from the first claim definition a description block associated with one of the one or more elements, the description block describing, elaborating, and/or enabling the one element; and
outputting the description block as part of the generated written description.

9. The method of claim 8, further comprising:
receiving from the description block a reference to a text block; and
outputting the text block as part of the description block output as part of the generated written description.

10. The method of claim 7, further comprising: generating a link from the generated claim to the generated written description, the link operable to provide access to the generated written description from the generated claim.

11. The method of claim 7, further comprising:
inserting the generated written description into a template document;
inserting the generated claim into the template document; and
outputting a draft patent specification that includes the generated written description and the generated claim.

12. The method of claim 1, further comprising:
generating a flow diagram based on the first claim definition, the flow diagram comprising boxes that each include an element from the first claim definition; and
outputting the generated flow diagram.

13. The method of claim 12, wherein the generating a flow diagram includes:
generating a figure number for the flow diagram; and
generating a reference number for each of the boxes of the flow diagram.

14. The method of claim 12, further comprising: for each of the boxes of the flow diagram, generating written description corresponding to the element of the box, based at least in part on a description block that is part of the first claim definition and that is associated with the element, the description block describing, elaborating, and/or enabling the element.

15. The method of claim 14, further comprising:
inserting the generated written description into a template document;
inserting the generated claim into the template document; and
outputting a draft patent specification that includes the generated written description and the generated claim.

16. The method of claim 1, further comprising:
receiving an indication of a claim type as part of the first claim definition, the type identifying one of a method claim, an apparatus claim, or an article of manufacture claim; and
automatically generating a second patent claim based on the first claim definition, the second patent claim being of a different claim type than the first claim.

17. The method of claim 1, further comprising:
automatically generating a redlined document that reflects changes between a first version of the first claim definition and a second version of the first claim definition; and
associating the first claim definition with prosecution history information, including at least one of a cited prior art reference, an action or document received from a patent office, a patent office filing, and/or a deadline.

18. The method of claim 1, further comprising:
providing a graphical user interface configured to automatically prepare the at least a portion of the patent application, by:
receiving a second claim definition that represents a dependent claim that depends on an independent claim represented by the first claim definition;
presenting a graph that includes a first node that represents the first claim definition, a second node that represents the second claim definition, and a link that connects the first and second node, wherein each node displays text corresponding to one or more claims elements of the first and second claims;
automatically generating a first and second patent claim respectively based on the first and second claim definitions; and
outputting the generated patent claims as the at least the portion of the patent application.

19. The method of claim 18, further comprising:
receiving from a user a selection of a textual portion of the first claim definition;
receiving from the user an indication to add a dependent claim that further defines the selected textual portion;
presenting a third node that represents a third claim definition that represents the dependent claim that further defines the selected textual portion, wherein the third node is linked to the first node and/or linked to the selected textual portion;
receiving from the user an indication to add a dependent claim that adds one or more elements to the first claim; and
presenting a fourth node that represents a fourth claim definition that represents the dependent claim that adds one or more elements to the first claim, wherein the fourth node is linked to the first node.

20. A non-transitory computer-readable medium including contents that are configured, when executed, to cause a computing system to perform a method for computer-assisted patent application preparation, the method comprising:
automatically preparing at least a portion of a patent application, by:
receiving a first claim definition that includes a preamble and one or more elements;
automatically generating a first patent claim based on the first claim definition; and
outputting the generated patent claim as the at least the portion of the patent application.
